(19) United States
(12) Patent Application Publication
(10) Pub. No.: US 2009/0254503 A1
(43) Pub. Date: Oct. 8, 2009

(54) METHOD AND SYSTEM FOR AUTOMATED EXPERTISE EXTRACTION

(75) Inventors: Shlomo Hoory, Haifa (IL); Oded Margalit, Ramat Gan (IL); Elad Yom-Tov, DN Hamovil (IL)

Correspondence Address: IBM-ACC-Washington;c/o Myers Dawes Andras & Sherman, LLP, 19900 MacArthur Blvd., 11th Floor, Irvine, CA, 92612, US

(73) Assignee: International Business Machines Corporation, Armonk, NY (US)

(21) Appl. No.: 12/062,465

(22) Filed: Apr. 3, 2008

(51) Int. Cl. G06F 17/00

(52) U.S. Cl. 706/46

(57) ABSTRACT

A method and system for expertise extraction for an expert system, is provided. One implementation involves modeling active learning for interrogating an expert for knowledge as attributes of an n-dimensional hyper-cube where each attribute represents a possible output and every dimension represents a feature in a feature space; dividing the n-dimensional hyper-cube into m different attributes, each attribute representing a union of at most p cubes, wherein the n dimensions represent n boolean inputs and the m attributes represent m possible outputs; and discovering all possible outputs by querying a portion of the feature space for generating queries to an expert for all possible outputs, including obtaining at least one representative input for each of the m possible outputs, while using a limited number of queries to the hyper-cube.

### BACKGROUND OF THE INVENTION

1. Field of the Invention

The present invention relates generally to information extraction and in particular to automated expertise extraction.

2. Background Information

One of the most important phases in an expert system process is the teaching phase. In this phase knowledge is extracted (e.g., from a human expert) and transformed into rules.

There are two general approaches for implementing information extraction. The first approach involves providing the human expert a language in which he/she would describe his/her knowledge. The second approach involves a machine learning techniques to extract rules from examples.

In the first approach the problem is that the expert does not necessarily know how to write rules or to cover her/his entire knowledge. The problem with the second approach is that many examples are needed before any valid rules can be deduced.

### SUMMARY OF THE INVENTION

The invention provides a method and system for an active learning system in which a process interrogates the expert to help us learn his/her knowledge. One embodiment involves modeling active learning for interrogating an expert for knowledge as attributes of an n-dimensional hyper-cube where each attribute represents a possible output and every dimension represents a feature; dividing the n-dimensional hyper-cube into m different attributes, each attribute representing a union of at most p cubes, wherein the n dimensions represent n boolean inputs and the m attributes represent m possible outputs; and discovering all possible outputs by querying a portion of the feature space for generating queries to an expert for all possible outputs, including obtaining at least one representative input for each of the m possible outputs, while using a limited number of queries to the hyper-cube.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the invention, as well as a preferred mode of use, reference should be made to the following detailed description read in conjunction with the accompanying drawings, in which:

FIG. 1 shows a functional block diagram of an automated expertise extraction, according to an embodiment of the invention.

FIGS. 2-7 show example processes for automated expertise extraction, according to an embodiment of the invention.

### DESCRIPTION OF THE PREFERRED EMBODIMENTS

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

The invention provides a method and system for an active learning system in which a process interrogates the expert to help us learn his/her knowledge. The expertise extraction is modeled as coloring of an n-dimensional hyper-cube where each color (attribute) denotes a possible output and every dimension is a feature. A process to discover all the possible outputs involves querying a small portion of the large space of feature values.

Assuming that the true model is that the n-dimensional hyper-cube is divided into m different colors, each one of them is a union of at most p cubes. An extraction process generates queries to an expert until we see all possible outputs.

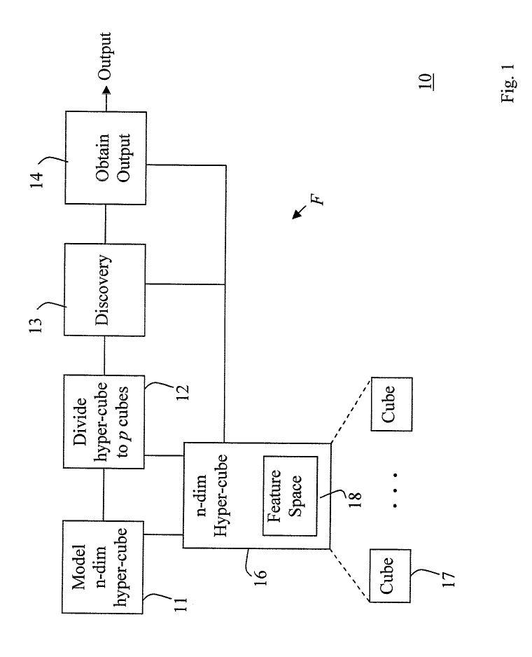

Referring to the functional block diagram 10 in FIG. 1, one embodiment involves the following process blocks:
Block 11: Modeling active learning for interrogating an expert for knowledge as attributes of an n-dimensional hyper-cube 16 where each attribute represents a possible output and every dimension represents a feature, defining a feature space 18.
Block 12: Dividing the n-dimensional hyper-cube 16 into m different attributes, each attribute representing a union of at most p cubes 17, wherein the n dimensions represent n boolean inputs and the m attributes represent m possible outputs.
Block 13: Discovering all possible outputs by querying a portion of said feature space in the hyper-cube 16 for generating queries to an expert for all possible outputs.
Block 14: Obtaining at least one representative input for each of the m possible outputs, while using a limited number of queries to the hyper-cube 16.

An example implementation as active learning the partition of the n-dimensional hyper-cube into m cubes, is described below. The model is exact learning via membership queries and without equivalence queries. An example randomized algorithm solves this problem in essentially O(m² log n) expected number queries (which is tight), while its expected running time is essentially O(m²n log n). The cube is partitioned/divided into m parts, where each part is the union of p cubes. Two randomized processes are provided. The first uses O(mp²2^{p} log n) expected number of queries, which is almost tight with the lower bound. It has a running time which is exponential in n. The second process achieves a better running time complexity of {tilde under (O)}(m²n²2²^{^{p}}) with an arbitrarily small probability of error, and expected number of queries {tilde under (O)}(mn4^{p}), where the tilde denotes the suppression of a polylogarithmic factor in m, n and 2^{p}.

Software/hardware modules can implement the process as a function F defined on n boolean inputs. At least one representative input for each of the m possible output values of F is obtained, while using a reasonably small number of queries to the function F. Simple examples, such as the case where a single point is colored red and the rest are colored blue, show that this problem cannot, in general, be solved using less than Ω(2ⁿ) expected number of queries. Therefore, restrictions are imposed on the function F. In what follows, several possible such restrictions are provided. Any non process must use active learning.

The problem of obtaining one example from each color, representative discovery, is closely related to the more difficult problem of obtaining a full description of the partition discovery. In some cases, there is a substantial difference between the two problems. For example, if F is the partition of the hyper-cube into two cubes, then the representative discovery problem can be solved without performing any query, as any two antipodes must have different colors. On the other hand, since the partition discovery algorithm has n possible outputs and gains at most one bit of information from each query, one cannot discover the partition using less than log₂ n queries. The invention considers specific concept classes (families of partitions), wherein the two problems are virtually equivalent for these concept classes. Namely, the processes herein solve the more difficult partition discovery problems, while being almost optimal with respect to the easier representative discovery problems.

We first consider the concept class, denoted by ρ, including partitions in which each color class is a sub-cube. A partition discovery algorithm uses at most m(3+log n) expected number of queries. This result significantly improves upon the mn upper bound and is optimal up to a constant factor, even as a representative discovery process. Next, we consider a generalization ρₚ of the concept class ρ that allows each color class to be the (not necessarily disjoint) union of at most p sub-cubes. A partition discovery algorithm is provided for ρₚ using at most O(mp²2^{p} log n) expected number of queries, and we show an almost matching lower bound of Ω(m2^{p} log n), again for the easier problem of representative discovery.

The running time of each algorithm comprises two parts: the time needed for the expert to answer the queries, and the time required for choosing the queries. We show a bound of O(m²n log n) on the running time for the concept class ρ. Another process for the concept class ρₚ has an arbitrarily small probability of error ε, with an expected running time bounded by {tilde under (O)}(m²n²2²^{^{p}} log(1/ε)) and expected number of {tilde under (O)}(mn4^{p} log(1/ε)) where the tilde denotes the suppression of a polylogarithmic factor in m, n and 2^{p}.

The problem of learning a partition of the n-cube into m p-cubes, is closely related to the problem of learning decision trees. We demand that all colors would be p-cube to simultaneously learn m disjoint Disjunctive Normal Forms.

### Learning Partitions to Cubes

Suppose the n-dimensional cube is partitioned into m sub-cubes C₁ through Cₘ. For any point xε{0,1}ⁿ let c(x) denote its color, which is the unique i satisfying xεCᵢ. A possibly randomized process is employed which uses a small (expected) number of color queries to determine the m sub-cubes.

For ease of understanding of the description below, certain notation is described first. The projection along the j-th of cube coordinate is denoted πⱼ, and in general πⱼ for projection on a set of coordinates J. A sub-cube is a non-empty set Tε{0,1}ⁿ that can be written as the Cartesian product π₁(T)× . . . ×πₙ(T). The support of T, denoted supp(T), is the set of coordinates j with |πⱼ(T)|=2, so dim(T)=|supp(T)|. The convex hull of a non-empty set S⊂{0,1}ⁿ, is the intersection of all the sub-cubes containing S. Equivalently, conv(S)=π₁(S)× . . . ×πₙ(S).

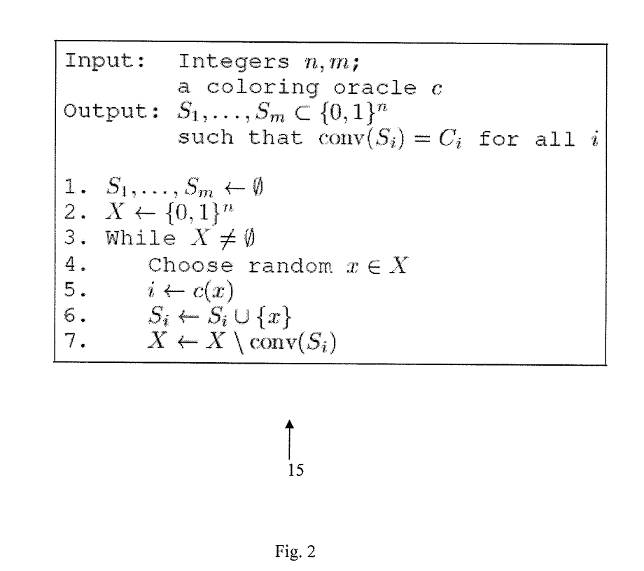

Consider the randomized process 15 in FIG. 2 (Algorithm A). Algorithm A is both efficient in terms of the expected number of color queries and in terms of running time. Moreover, if m is not too large compared with n, the expected number of queries is best possible up to a constant factor.

Algorithm A is a partition discovery algorithm for the concept class ρ, using at most (3+log n) expected number of queries. After any iteration of the algorithm A, we have X={0,1}ⁿ\∪ᵢ₌₁^{m} conv(Sᵢ). Since all points in Sᵢ are colored i, all points in conv(Sᵢ) must be colored i. Upon termination, X=0, such that the union of conv(Sᵢ) is the entire cube. Therefore, the color of all points is known, proving the correctness of the algorithm. We now turn to upper-bound the expected number of queries. Consider a color i. We measure the progress made by the algorithm A in color i by dim(conv(Sᵢ)) from the first time color i was hit, where dim(conv(Sᵢ))=0, to its final value dim(Cᵢ). Suppose that at some step, the algorithm sampled the point x of color i. Let S, Sₓ denote the value of conv(Sᵢ) before and after updating for x, and let C denote Cᵢ. Note that we have S⊂Sₓ⊂C. The following inequality holds:

```
    Eₓ [dim(C) − dim(Sₓ)] ≦ (dim(C) − dim(S)) / 2 ,
  where the distribution of x is uniform on C \ S . Consider a coordinate
j in supp(C) \ supp(S) . Then:
  j is in supp(Sₓ) iff xⱼ ≠ sⱼ, where xⱼ is the j - th coordinate of x,
  and sⱼ is the unique value in πⱼ(S) ’
```

By linearity of expectation it suffices to prove that Pr[xⱼ≠sⱼ]≧½ for all such j. Indeed:

$$Pr [ {x}_{j} \neq {s}_{j} ] = \frac{\vert C \vert / 2}{\vert C \backslash S \vert} \geq \frac{\vert C \vert / 2}{\vert C \vert} = \frac{1}{2} .$$

The above inequality implies that after k+1 hits to color i:

E[dim(Cᵢ)−dim(Sᵢ)]≦(dim(Cᵢ)/2^{k}≦n/2^{k}.

Therefore the probability that Sᵢ≠Cᵢ after k+1+log n hits to color i is bounded by 2^{-k}. This implies that the expected number of hits required to exhaust color i is at most 3+log n. The required result follows by linearity of expectation.

Algorithm A can be efficiently implemented, so that its expected running time is about O(m log n). Checking if X is empty and random sampling from X can be efficiently implemented. We observe that for any cube C we can efficiently compute the cardinality of x∩C=C\∪ᵢ₌₁^{m}conv(Sᵢ). Indeed, the disjointedness of conv(Sᵢ) implies that |X∩C|=2^{|dim(C)|}−Σᵢ2^{dim(C∩conv(S}_{ᵢ}⁾⁾, where the sum ranges over i such that C∩Sᵢ is non-empty. For such i, the dimension of C∩n conv(Sᵢ) is just the number of coordinates in (c)∩supp(Sᵢ).

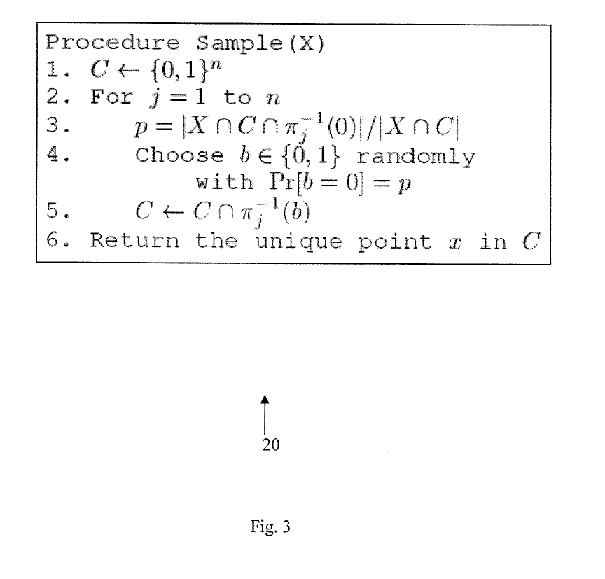

For C={0,1}ⁿ the above observation solves the problem of checking whether X is empty. As for random sampling from X, we use the basic paradigm that counting and random sampling is equivalent. Specifically, we perform the procedure Sample 20 described in FIG. 3. Note that for j>1, line 3 can be performed in O(1) time, by keeping the sets supp(c)∩supp(Sᵢ) from the previous iteration, and performing the update only for coordinate j. It follows that the time needed to produce a uniformly random point from X (or prove no such point exists) is O(mn), which yields the required bound.

Any partition discovery algorithm for the concept class ρ requires at least Ω(m log n), as long as 2≦m≦2^{n/2}. The same bound holds also for representative discovery, as long as 3≦m≦2_{n/2}. Note that, as mentioned before, if m=2, a non-trivial lower bound is needed for the representative discovery problem, since any two antipodes have different colors. If m=2, any partition discovery algorithm requires at least log n queries since there are n possible partitions in ρ, and each query gives the algorithm at most one bit of information. Therefore, from now on we can restrict our attention to the representative discovery problem for 3≦m≦2^{n/2}. Without loss of generality, m=3·2^{l} for a non-negative integer l.

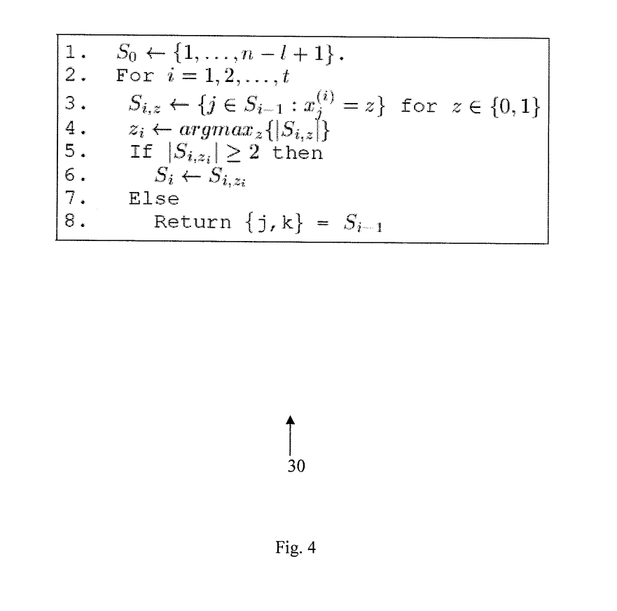

Let A′ be some representative discovery algorithm. We want to answer the color queries of the algorithm consistently, while ensuring the algorithm requires many color queries. When queried on the point xε{0,1}ⁿ, we determine its color c(x) as follows. The trailing l bits of c(x) are just the trailing l bits of x, which we denote by y. The value of the remaining two bits, which has three possible values, is determined by performing a table lookup. The table {00,00,01,10} is fed with the two input bits xⱼ and xₖ for distinct indices j,kε{1, . . . , n-l+1} that are determined based on the past queries A′. Let x⁽¹⁾, x⁽²⁾, . . . , x^{(t)}=x be the sequence of past queries made by A′ to points whose trailing bits are y. Then j, k are determined by the process 30 in FIG. 4. This process produces a valid coloring for which the algorithm must make many color queries to find a representative for each color.

A partition matching all answers made to the algorithm is now described. The partition is defined by first partitioning the n-cube into 2^{l}=m/3 subcubes {C_{y}} according to the trailing l bits, y. The partition is further refined by partitioning each sub-cube into three sub-cubes according to the output of the lookup table for the two coordinates j_{y}, k_{y}. It remains to show that, for each y, one can exhibit values for j_{y}, k_{y} that are consistent with all answers made by the process 30. This follows from the fact that the sets calculated by process 30 satisfy Sᵢ⊃Sᵢ₊₁, and that as long as |Sₜ|>2, all indices in Sₜ are equivalent for the first t queries to points in C_{y}.

As long as |Sₜ|>2, the answer to the query c(x) is 00y or 10y. Therefore, since A′ must hit also 01y in order determine the partition of C_{y}, it must ask sufficiently many queries in C_{y} to ensure that |Sₜ|=2. Since |Sᵢ₊₁|≧|Sᵢ|/2 for all i, this requires at least log(n-l) queries to points in C_{y}. Therefore, discovering the partition requires at least (m/3)·log(n-l), which is Ω(m log n) as discussed.

### Learning Partitions to P-Cube

A subset of the cube is a p-cube if it can be expressed as the union of at most p cubes, not necessarily disjoint. The above process for p=1 and be generalized to arbitrary integers p≧1. We denote the concept class of partitions into p-cubes by ρₚ. Given an efficient partition/representative discovery algorithm with respect to ρₚ, the definition of conv can be generalized as follows:

$${conv}_{p} ( S ) = ⋂ {⋃}_{i = 1}^{p} conv ( {S}_{i} ) . \\ {S}_{1} , … , {S}_{p}$$

$$partitions of S .$$

Consider algorithm Aₚ, obtained from algorithm A above by replacing conv with convₚ. Then, algorithm Aₚ discovers any partition from the concept class ρₚ within at most O(mp²2^{p} log n) expected number of queries. As for the case p=1, algorithm Aₚ is almost tight with respect to the number of color queries.

Any representative discovery algorithm for ρₚ requires at least Ω(mp²2^{p} log n) color queries, as long as 2≦m≦2^{n/2} and p>1. If the union of p cubes C₁, . . . , Cₚ⊂{0,1}ⁿ is not the entire n-cube, then there is set J of at most p coordinates such that |πⱼ(∪ᵢ₌₁^{p}Cᵢ|)<2^{|j|}. For any cubes C₁, . . . , Cₚ⊂{0,1}ⁿ, one of the following is true: (1) C=∪ᵢ₌₁^{p}Cᵢ, or (2) |∪ᵢ₌₁^{p}Cᵢ/|C∥≦1−2^{-p}. For any two subsets S, T of the n-dimensional cube, convₚ(S∪T)⊃convₚ(S)∪convₚ(T). For any subset S and point xεconvₚ(S), then convₚ(S∪{x})=convₚ(S).

Let A′ₚ be some representative discovery algorithm for ρₚ. Let n, m, p be three integers satisfying the requirements that any representative discovery algorithm for ρₚ requires at least Ω(mp²2^{p} log n) color queries, as long as 2≦m≦2^{n/2} and p>1. Then, color queries are determined. m=2^{l} for some l≧1. We build the partition (i.e., dividing the hyper-cube) in two stages. First, we partition (block 12, FIG. 1) the n-cube 16 into 2^{l-1} sub-cubes 17 according to the trailing l−1, {C_{y}:yε{0,1}^{l-1}}. Then, for each y, we choose a set J_{y} of p coordinates from {1, . . . , n−1}, and a length p bit string α_{y}. We color the cube C_{y} by two colors so that xεC_{y} is colored y0 if πⱼ_{_{y}} (x)=α_{y}, and is colored y1 otherwise. The parameters J_{y} and α_{y} can be adjusted according to the answers of process A′ₚ. Response to a color query c(x) is computed as follows: Let Q be the set of past queries made by A′ₚ to points in C_{y}, including the last query to x. Then, as long as we have some J⊂{1, . . . , n-l} of size p and αε{0,1}^{p} satisfying α∉πⱼ(Q), we answer y0. This is in agreement with the above partition for any such (J, α). The first time when all (J, α) pairs have been eliminated, we set (J_{y}, α_{y}) to be one of the last (J, α) pair to survive. All subsequent queries to the C_{y} cube are answered by the above partition. This algorithm yields a valid coloring.

The minimal number of points in C_{y} covering all such (J, α) pairs is Ω(2^{p} log(n-l+1)). Therefore, since there are 2^{l-1}=m/2 possible values for y, we obtain that the total number of queries A′ₚ needs is Ω(2^{p}m log n).

Efficient Learning Partitions into P-Cubes

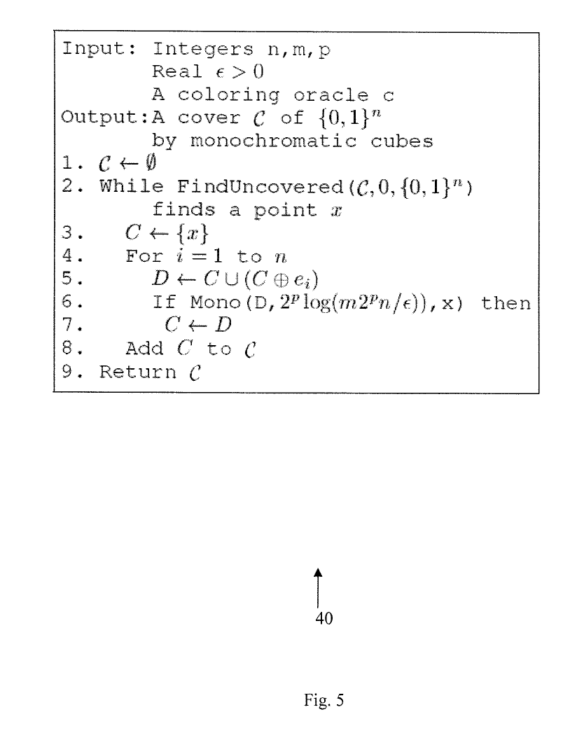

Although Aₚ above uses an essentially optimal number of queries. A more computationally process 40 in FIG. 5 (algorithm B), provides a computationally efficient partition discovery process (block 13, FIG. 1) for the concept class ρₚ. Algorithm B reduces query complexity and has an arbitrarily small error probability.

Given some ε>0, algorithm B is a partition discovery algorithm for ρₚ, with error probability at most ε. Let k=┌2^{p} log(m2^{p}n/ε)┐. Then the expected running time for algorithm B is O(mn²2^{p}[m2²^{^{p}}+k]), while the expected number of queries is O(kmn2^{p}). Algorithm B in FIG. 4, covers the n-cube by monochromatic cubes. The main loop, lines 2-8 finds a maximal monochromatic sub-cube C containing x, as long as there exists an uncovered point x, and add C to the cover. Lines 3-7 in algorithm B finds a maximal monochromatic sub-cube C containing x. This is done by starting with C={x}, and scanning the coordinates from 1 to n. For each coordinate i, if the cube D is obtained by turning the i-th coordinate of C into a star that is still monochromatic, then replace C by D. The maximum cube is the cube C after the completion of the loop.

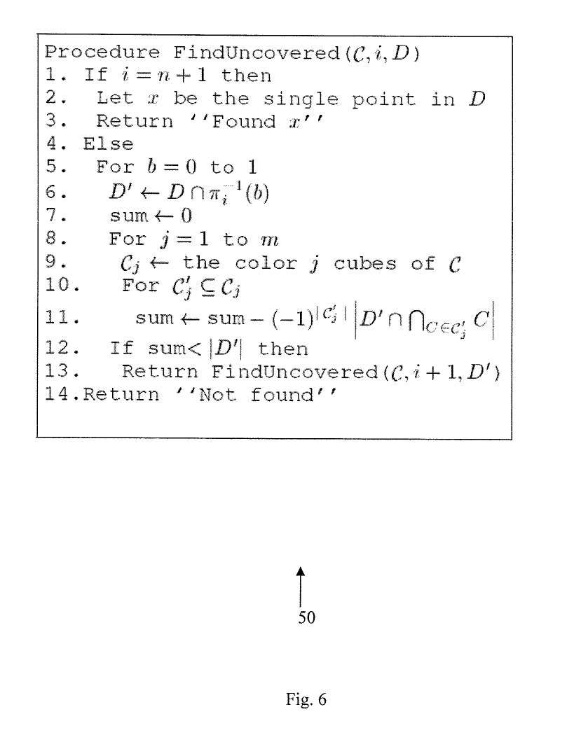

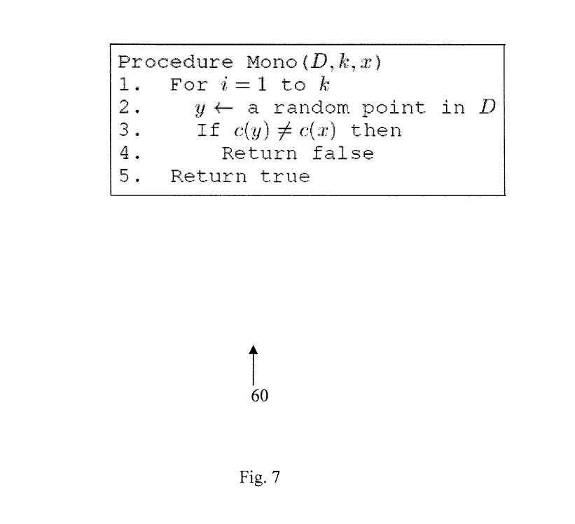

Line 6 of algorithm B checks if a cube D is monochromatic. This task is performed (process 60, FIG. 7) by sampling sufficiently many random points in D and verifying that all have the same color. Line 2 of algorithm B finds a point x that is uncovered by the cubes found so far. An implementation 50 in FIG. 6 uses a similar paradigm to the one used in procedure Sample in FIG. 3. The size of the covered part within a cube D is calculated by applying an inclusion-exclusion formula.

A sub-cube is represented by a string in {0,1,*}ⁿ. In line 5 of FIG. 5, C⊕eᵢ denotes the exclusive-or of C with the i-th unit vector. The resulting D is calculated by changing coordinate i into a star. Line 9 of procedure FindUncovered in FIG. 6, does not require any actual computation, since the set C can be represented as m sets C₁, . . . , Cₘ in the first place. Line 9 of procedure FindUncovered in FIG. 6 can be implemented to run in time O(1). This follows by observing that for i>1, the intersection D∩∩_{CεC′}_{₁}C is known from the previous iteration, and that the required update comprises a local update for coordinate i.

The main while loop (lines 2-9, FIG. 5) will discover at most 2^{p} cubes of each color. Consequently, it will perform at most m2^{p} iterations. It is sufficient to scan the coordinates once in order to find a maximum monochromatic cube containing x in lines 4-7 (FIG. 5). Procedure Mono (FIG. 7) has a probability error at most (1−2^{-p})^{k} in one invocation. The probability that procedure Mono has an error throughout the execution of algorithm B is at most ε. Assuming that Mono has no errors throughout the run of the algorithm B, the procedure FindUncovered (FIG. 6) finds an uncovered point x if and only if there is such a point. Its total run time is O(nm2²^{^{p}}).

As is known to those skilled in the art, the aforementioned example embodiments described above, according to the present invention, can be implemented in many ways, such as program instructions for execution by a processor, as software modules, as computer program product on computer readable media, as logic circuits, as silicon wafers, as integrated circuits, as application specific integrated circuits, as firmware, etc. Though the present invention has been described with reference to certain versions thereof; however, other versions are possible. Therefore, the spirit and scope of the appended claims should not be limited to the description of the preferred versions contained herein.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

1. A method, comprising:
employing a processor for automated expertise extraction in a learning module of an expert system, by:
extracting knowledge from a human expert by interrogating the expert for inputting knowledge comprising data input into the system;
storing the extracted knowledge data in a memory device as attributes of an n-dimensional hyper-cube data structure model each attribute represents a possible output and every dimension represents a feature;
processing the stored knowledge data by dividing the n-dimensional hyper-cube into m different attributes, each attribute representing a union of at most p cubes, wherein the n dimensions represent n Boolean inputs of the system and the m attributes represent m outputs of the system; and
providing output from the system comprising discovering all possible outputs by querying a portion of the feature space of the hypercube;
wherein extracting knowledge further comprises automatically generating queries to the expert, including obtaining at least one representative input for each of the m possible outputs, while using a limited number of queries,
reporting knowledge of the expert comprising all possible outputs which may be given by the expert, and a representative example of each output, as well as the inputs which led the expert to each output.
